(19) United States
(12) Patent Application Publication
(10) Pub. No.: US 2024/0375899 A1
(43) Pub. Date: Nov. 14, 2024

(54) SHEET CONVEYANCE APPARATUS, IMAGE FORMING APPARATUS, AND IMAGE FORMING SYSTEM

(71) Applicant: CANON KABUSHIKI KAISHA, Tokyo (JP)

(72) Inventors: YUTAKA KOGA, Chiba (JP); TAKUYA KAWASUMI, Chiba (JP); YORITSUGU MAEDA, Ibaraki (JP); MASAHIRO SHINOTSUKA, Ibaraki (JP)

(21) Appl. No.: 18/644,316

(22) Filed: Apr. 24, 2024

(30) Foreign Application Priority Data
May 12, 2023 (JP) 2023-079472

(51) Int. Cl. B65H 9/00; B41J 13/00; B65H 5/06

(52) U.S. Cl. CPC B65H 9/002; B41J 13/0018; B65H 5/068

(57) ABSTRACT

A sheet conveyance apparatus includes a conveyance unit and a skew correction unit. The skew correction unit includes a first skew correction roller pair, a second skew correction roller pair, a first motor, and a separate mechanism. The separate mechanism includes an interlocking member configured to interlock a first driven roller and a second driven roller. The separate mechanism moves the first driven roller and the second driven roller to contact positions and separated positions by driving the first motor to move the interlocking member, the contact positions being positions where the first driven roller and the second driven roller respectively come into contact with a first drive roller and a second drive roller, the separated positions being positions where the first driven roller and the second driven roller are respectively separated from the first drive roller and the second drive roller.

### BACKGROUND OF THE INVENTION

### Field of the Invention

This disclosure relates to a sheet conveyance apparatus that corrects the skew of a conveyed sheet, an image forming apparatus, and an image forming system.

### Description of the Related Art

For example, in image forming apparatuses forming an image on a sheet, so as to form the image without inclination with respect to the sheet, skew correction unit for correcting the skew of the sheet that is conveyed to image forming units is disposed. As such skew correction unit, an image forming apparatus including a plurality of registration roller pairs that are independently rotatable in a sheet width direction is suggested (refer to Japanese Patent Laid-Open No. 2010-42903). In the image forming apparatus of this Japanese Patent Laid-Open No. 2010-42903, each of the registration roller pairs can change a rotational speed, and the sheet is swiveled to correct the skew of the sheet by swiveling each of the registration roller pairs.

In the image forming apparatus of this Japanese Patent Laid-Open No. 2010-42903 described above, each of the registration roller pairs includes a drive roller and a driven roller that is rotatably driven by coming into contact with the drive roller. Further, by disposing a separate mechanism that allows movements of the driven rollers, the image forming apparatus can switch between a contact state in which the drive and driven rollers form nips, and a separated state in which the driven rollers are separated from the drive rollers and the nips are separated. Further, in this separate mechanism, solenoid is used as driving source for moving the driven rollers.

However, in a case of apparatuses such as, for example, commercial printing machines that print a large volume of the sheets, the use of the solenoid in the separate mechanism as described above poses issues regarding the durability of the solenoid itself. Since, in its structure, the solenoid operates by sliding such as a plunger, the solenoid is susceptible to wear due to repeated disengagement and engagement actions of the driven roller. Therefore, the adoption of a motor (i.e., rotary electric machine) as the driving source of the separate mechanism is expected to improve the durability. However, in a case of adopting the motor as the driving source, a mechanism to convert a rotational motion of the motor into the disengagement and engagement actions of the driven roller becomes necessary. Therefore, incorporation of such a mechanism necessitates a considerable expansion of space, and there is a risk that the size of the entire apparatus may increase.

Therefore, the purpose of this disclosure is to provide a sheet conveyance apparatus, an image forming apparatus, and an image forming system that can ensure to miniaturize the apparatuses while improving the durability of the skew correction unit.

### SUMMARY OF THE INVENTION

According to a first aspect of the present invention, a sheet conveyance apparatus includes a conveyance unit configured to convey a sheet, and a skew correction unit configured to correct skew of the sheet conveyed by the conveyance unit. The skew correction unit includes a first skew correction roller pair, a second skew correction roller pair, a first motor, and a separate mechanism. The first skew correction roller pair includes a first drive roller and a first driven roller arranged to face the first drive roller and configured to be rotatably driven by the first drive roller. The second skew correction roller pair includes a second drive roller and a second driven roller arranged to face the second drive roller and configured to be rotatably driven by the second drive roller, the second skew correction roller pair being provided in alignment with the first skew correction roller pair in a width direction perpendicular to a sheet conveyance direction. The separate mechanism includes an interlocking member configured to interlock the first driven roller and the second driven roller. The separate mechanism is configured to move the first driven roller and the second driven roller to contact positions and separated positions by driving the first motor to move the interlocking member, the contact positions being positions where the first driven roller and the second driven roller respectively come into contact with the first drive roller and the second drive roller, the separated positions being positions where the first driven roller and the second driven roller are respectively separated from the first drive roller and the second drive roller.

According to a second aspect of the present invention, an image forming apparatus includes the sheet conveyance apparatus, and an image forming unit configured to form an image on the sheet conveyed by the sheet conveyance apparatus.

According to a third aspect of the present invention, an image forming system includes the image forming apparatus, and a processing apparatus configured to perform processing on the sheet on which the image has been formed by the image forming apparatus.

Further features of the present invention will become apparent from the following description of exemplary embodiments with reference to the attached drawings.

### BRIEF DESCRIPTION OF THE DRAWINGS

FIG. 1 is a schematic diagram illustrating a schematic configuration of an inkjet recording system of the present embodiment.

FIG. 2 is a top view illustrating a registration unit of a print module of the present embodiment.

FIG. 3 is a perspective view illustrating the registration unit of the print module of the present embodiment.

FIG. 4A is a perspective view illustrating the registration unit before registration drive rollers are swiveled.

FIG. 4B is a perspective view illustrating the registration unit after the registration drive rollers have been swiveled.

FIG. 5A is a top view illustrating the registration unit before the sheet is conveyed.

FIG. 5B is a top view illustrating the registration unit in a state in which the skew correction of the sheet is being performed.

FIG. 5C is a top view illustrating the registration unit in which the lateral registration correction of the sheet is being performed.

FIG. 6 is a side cross-sectional view illustrating the registration unit of the print module of the present embodiment.

FIG. 7 is a flowchart illustrating the control of the print module of the present embodiment.

FIG. 8 is a cross-sectional view illustrating a registration roller pair of the present embodiment.

FIG. 9A is a diagram illustrating a state immediately after the registration drive roller has been swiveled.

FIG. 9B is a diagram illustrating a restoring force generated in a registration driven roller resulting from the swiveling of the registration drive roller.

FIG. 9C is a diagram illustrating a state in which the registration driven roller has swiveled due to the swiveling of the registration drive roller.

FIG. 10 is a perspective view illustrating a separate mechanism of the present embodiment.

FIG. 11A is a top view illustrating the separate mechanism of the present embodiment.

FIG. 11B is a front view illustrating the separate mechanism of the present embodiment.

FIG. 11C is a side view illustrating the separate mechanism of the present embodiment.

### DESCRIPTION OF THE EMBODIMENTS

Hereinafter, using drawings, an embodiment for implementing this disclosure will be described. In the present embodiment, a case where an inkjet recording system 1 is applied as an image forming system will be described.

### Inkjet Recording System

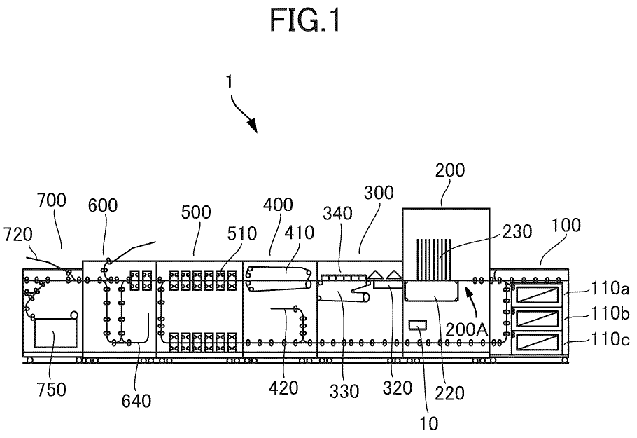

First, using FIG. 1, a schematic configuration of the inkjet recording system 1 of the present embodiment will be described. FIG. 1 is a diagram illustrating the schematic configuration of the inkjet recording system 1 of the present embodiment. As the image forming system, the inkjet recording system 1 is a sheet-fed inkjet recording system that produces a recorded matter on which an ink image is formed on a sheet S using a two-liquid system of reaction liquid and ink. As illustrated in FIG. 1, the inkjet recording system 1 is constituted from a feed module 100, a print module 200, a drying module 300, a fixing module 400, a cooling module 500, a reverse module 600, and a sheet discharge module 700. The sheet S, in a form of cut paper, supplied from the feed module 100 is conveyed along a sheet conveyance path, and, after having been processed in each of the modules, is discharged at the sheet discharge module 700, serving as a sheet supporting apparatus. Further, in the inkjet recording system 1, the image is formed in the print module 200, serving as an image forming apparatus, and various processing is performed on the sheet, on which the image has been formed, downstream of the print module 200 in a sheet conveyance direction. Therefore, such as the drying module 300, the fixing module 400, the cooling module 500, the reverse module 600, and the sheet discharge module 700 can be also referred to as processing apparatuses.

The feed module 100 includes three storage compartments 110a, 110b, and 110c that store the sheet S. Each of the storage compartments 110a, 110b, and 110c is drawable toward a front side of the apparatus. In each of the storage compartments 110a, 110b, and 110c, the sheet S is fed by a separation belt and a conveyance roller, not shown, one sheet at a time, and is conveyed to the print module 200. To be noted, the number of the storage compartments 110a, 110b, and 110c is not limited to three, and the feed module 100 may include one, or two, or equal to or more than four storage compartments.

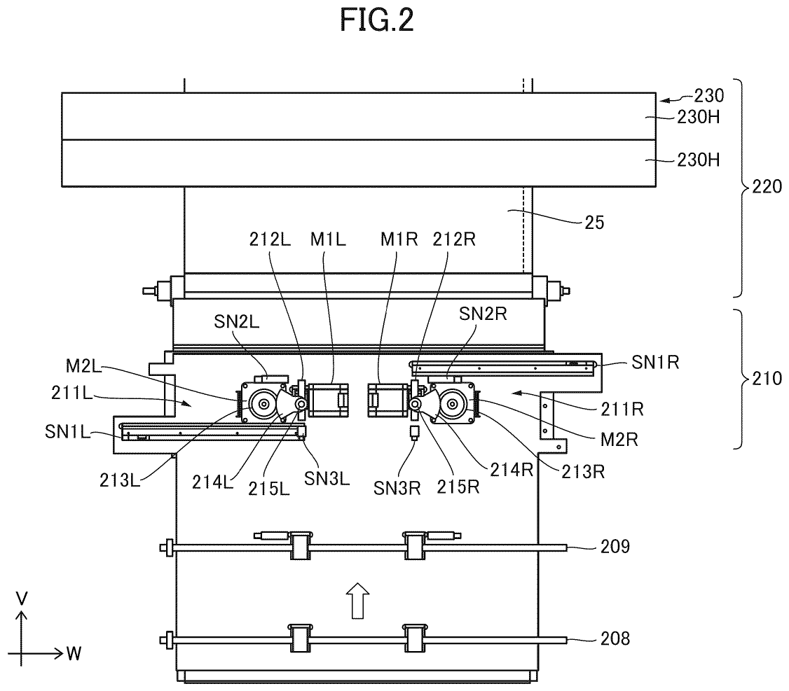

The print module 200 includes a registration unit 210, serving as a skew correction unit performing skew correction and lateral registration correction, described in detail below, before forming the image, a print belt unit 220, and a recording unit 230. The skew and a position of the sheet S conveyed from the feed module 100 is corrected by a plurality of conveyance roller pairs 208 and 209 (refer to FIG. 2), serving as a conveyance unit, and the registration unit 210, and the sheet S is conveyed to the print belt unit 220. The recording unit 230 is located at a position facing the print belt unit 220 with respect to the sheet conveyance path. These plurality of conveyance roller pairs 208 and 209 and the registration unit 210 form a sheet conveyance unit 201A, serving as a sheet conveyance apparatus conveying the sheet to the recording unit 230. Further, the recording unit 230 is an image forming unit that forms an image on the sheet S by performing recording processing (printing) with respect to the sheet S, which is conveyed, by a plurality of recording heads 230H (refer to FIG. 2) from above.

The plurality of recording heads 230H are arranged along the sheet conveyance direction. In the present embodiment, the recording unit 230 includes total of five line-type recording heads which corresponds to four colors: yellow (Y), magenta (M), cyan (C), and black (K), and an additional head for the reaction liquid added to these four colors. To be noted, the variety of colors and the number of the recording heads are not respectively limited to four and five. To an inkjet method, methods using such as a heating element, a piezoelectric element, an electrostatic element, and a micro electromechanical system (MEMS) element can be adopted. The ink of each color is supplied from an ink tank, not shown, to each of the recording heads through an ink tube. The sheet S that has been printed in the recording unit 230 is conveyed while maintaining clearance with the recording heads by being adsorptively conveyed by the print belt unit 220. The sheet S that has been printed in the recording unit 230 is detected for the misalignment and the color density of the image formed on the sheet S by an inline scanner, not shown, located on a downstream side of the recording unit in the sheet conveyance direction. Detection results are utilized for the correction of the printed image.

The drying module 300 includes a decoupling portion 320, a drying belt unit 330, and a warm air blowing portion 340, and improves the fixability of the ink to the sheet S by reducing a liquid content in the ink applied onto the sheet S in the recording unit 230 of the print module 200. The sheet S that has been printed in the recording unit 230 of the print module 200 is conveyed to the decoupling portion 320 located on an upstream side of the drying module 300 in the sheet conveyance direction. In the decoupling portion 320, it is possible to convey the sheet S through the pressure of airflow from above and the friction of a belt. By softly securing the sheet S on the belt during conveyance, the displacement of the sheet S, where the ink image is formed, on the print belt unit 220 is prevented. The drying belt unit 330 and the warm air blowing portion 340 are respectively arranged below and above the belt in a manner facing each other across the belt. The sheet S that has been conveyed from the decoupling portion 320 is adsorptively conveyed on the drying belt unit 330, and, at the same time, an ink application surface of the sheet S is dried by receiving hot air from the warm air blowing portion 340. To be noted, as a method of drying, instead of applying the hot air, it is acceptable to irradiate the surface of the sheet S with electromagnetic waves (such as ultraviolet and infrared rays), or it is acceptable to utilize combined methods that involve conductive heat transfer through contact with a heating body.

The fixing module 400 includes a fixing belt unit 410. The fixing belt unit 410 includes an upper belt unit and a lower belt unit, and can fix the ink on the sheet S by passing the sheet S conveyed from the drying module 300 through a gap between the heated upper belt unit and the lower belt unit.

The cooling module 500 includes a plurality of cooling units 510, and cools a high temperature sheet S that has been conveyed from the fixing module 400. By drawing outside air into cooling boxes with fans to increase the internal pressure of the cooling boxes, the cooling units 510 cool the sheet S by blowing the air emitted through nozzles, which are formed in a conveyance guide, onto the sheet S. The cooling units 510 are arranged on both upper and lower sides with respect to the sheet conveyance path, and cool the sheet S from both surfaces.

Further, the cooling module 500 includes a conveyance path switching portion, and can switch the sheet conveyance path of the sheet S depending on whether the sheet is conveyed to the reverse module 600 or to a duplex conveyance path used during duplex printing. During the duplex printing, the sheet S is conveyed through a sheet conveyance path located in a lower section of the cooling module 500. In this case, from the cooling module 500, the sheet S is further conveyed along duplex conveyance paths of the fixing, drying, print, and feed modules 400, 300, 200, and 100. A first reverse portion 420 that reverses front and back surfaces of the sheet S is disposed in the duplex conveyance path of the fixing module 400. Then, the sheet S is again conveyed from the feed module 100 to the registration unit 210, the print belt unit 220, and the recording unit 230 of the print module 200, and is printed in the recording unit 230.

The reverse module 600 includes a second reverse portion 640. The reverse module 600 can reverse the front and back surfaces of the conveyed sheet S, and can reverse the front and back surfaces of the discharged sheet S. The sheet discharge module 700 includes a top tray 720 and a supporting portion 750. The sheet discharge module 700 aligns and stacks the sheet S conveyed from the reverse module 600 onto the top tray 720 or the supporting portion 750, or discharges the sheet S to such as an external tray, not shown.

### Configurations of Registration Unit and Area Adjacent to Registration Unit in Print Module

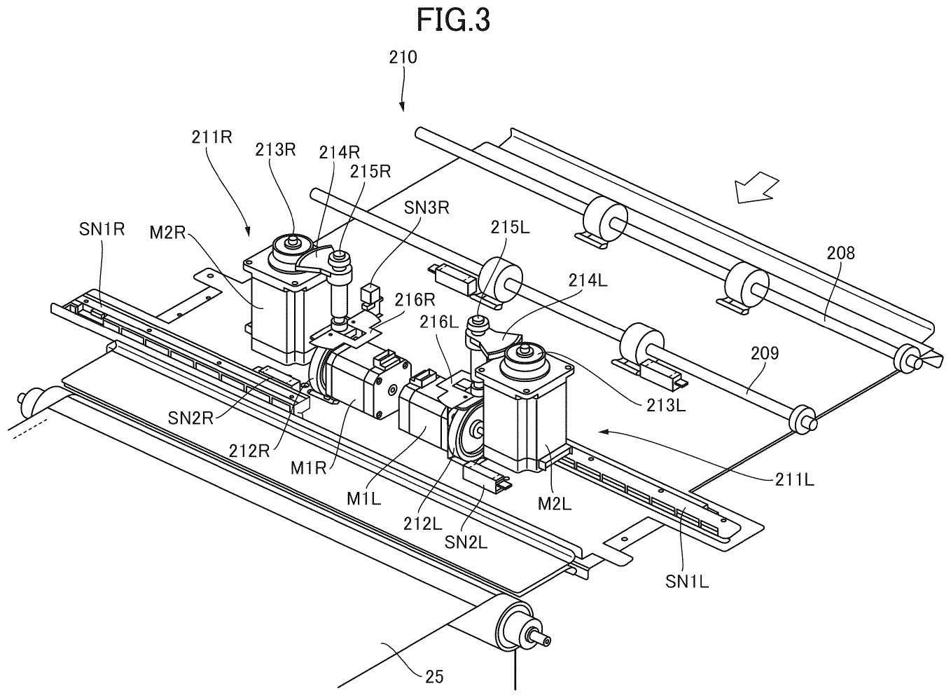

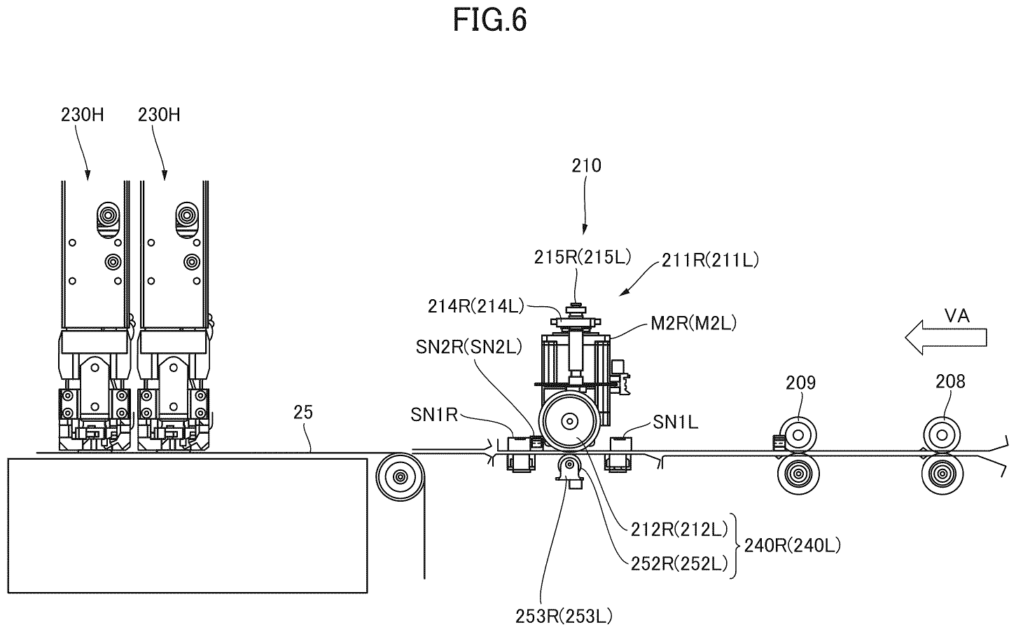

Next, using FIGS. 2, 3, and 6, configurations of the registration unit 210 and an area adjacent to the registration unit in the print module 200 described above will be described. FIG. 2 is a top view illustrating the registration unit of the print module of the present embodiment. FIG. 3 is a perspective view illustrating the registration unit of the print module of the present embodiment. FIG. 6 is a side cross-sectional view illustrating the registration unit of the print module of the present embodiment.

In the print module 200, as illustrated in FIGS. 2 and 3, in the sheet conveyance unit 200A (refer to FIG. 1), the conveyance roller pairs 208 and 209, which convey the sheet, are arranged in sequence in a sheet conveyance direction V. To be noted, each of these conveyance roller pairs 208 and 209 includes a lower roller including a roller made from, for example, ethylene-propylene-diene rubber (EPDM) and an upper roller including a rubber roller made from, for example, urethane, and the lower roller is urged toward the upper roller by a spring, not shown. To be noted, the term “sheet conveyance direction V” here refers to a direction in which the sheet is conveyed when the sheet is not skewing, and is not indicative of a conveyance direction during a steering operation, described below.

In a sheet conveyance unit 200A of the print module 200, the registration unit 210 that corrects the skew of the sheet conveyed by the conveyance roller pairs 208 and 209 is arranged downstream of the conveyance roller pairs 208 and 209 in the sheet conveyance direction V. Further, in the print module 200, the print belt unit 220 is arranged downstream of the registration unit 210 in the sheet conveyance direction V. The print belt unit 220 includes a print belt 25 that circulates in a manner adsorptively conveying the sheet, and a recording unit 230 (the plurality of recording heads 230H) (refer to FIG. 2) that forms the image on the sheet conveyed by the print belt 25.

### Registration Roller Pair

As illustrated in FIG. 6, the registration unit 210 includes a left registration roller pair (hereinafter, simply referred to as a registration roller pair) 240L, serving as a first skew correction roller pair, on a left side than a conveyance center with respect to the sheet conveyance direction V (refer to FIG. 2). Further, the registration unit 210 includes a right registration roller pair (hereinafter, simply referred to as the registration roller pair) 240R, serving as a second skew correction roller pair, in a form arranged in parallel on a right side than the conveyance center with respect to the sheet conveyance direction V (refer to FIG. 2). That is, the right registration roller pair 240R is provided in alignment with the left registration roller pair 240L in the sheet width direction. Further, the registration roller pair 240L includes a registration drive roller 212L, serving as a first drive roller, and a registration driven roller 252L, serving as a first driven roller. The registration driven roller 252L is arranged to face the registration drive roller 212L, and is driven in a case of coming into contact with the registration drive roller 212L. Further, the registration roller pair 240R similarly includes a registration drive roller 212R, serving as a second drive roller, and a registration driven roller 252R, serving as a second driven roller. The registration driven roller 252R is arranged to face the registration drive roller 212R, and is driven in a case of coming into contact with the registration drive roller 212R. To be noted, the registration drive rollers 212L and 212R are rubber rollers made from, for example, polyurethane, and the registration driven rollers 252L and 252R are rollers made from, for example, EPDM.

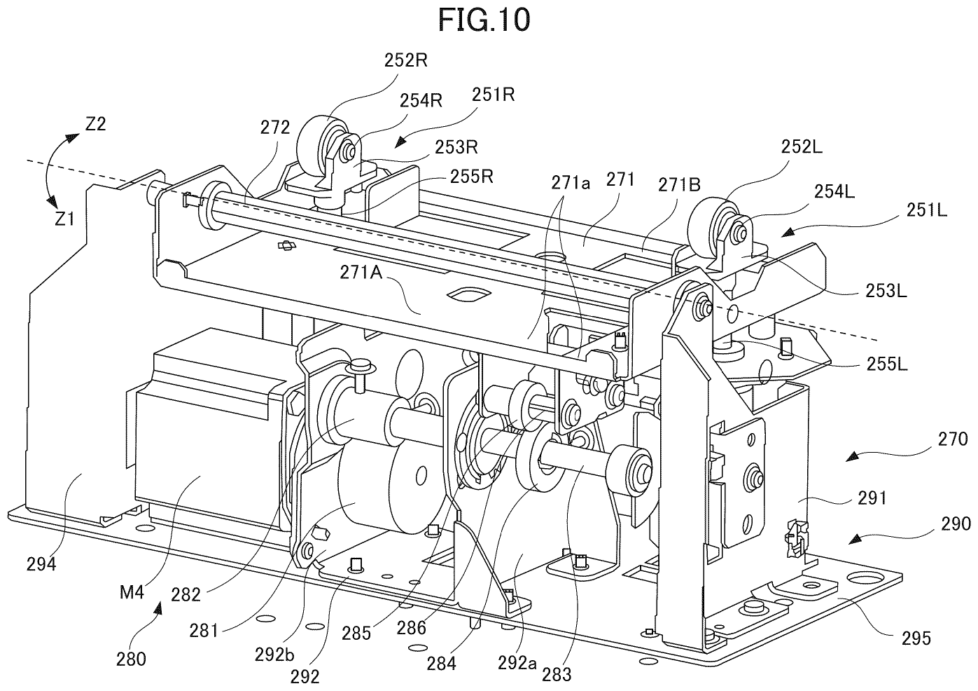

To be noted, by a separate mechanism 270 (refer to FIG. 10), the registration driven rollers 252L and 252R of these registration roller pairs 240L and 240R are configured to be moved to contact positions where the registration driven rollers 252L and 252R respectively come into contact with the registration drive rollers 212L and 212R, and to separated positions where the registration driven rollers 252L and 252R are respectively separated from the registration drive rollers 212L and 212R. The registration driven rollers 252L and 252R and the separate mechanism 270 configured as described above will be collectively described in detail below.

### Drive Swivel Mechanism

Next, drive swivel mechanisms 211L and 211R in the registration unit 210 will be described. As illustrated in FIGS. 2 and 3, the registration unit 210 includes the drive swivel mechanisms 211L and 211R which respectively rotatably drive and swivel the registration drive rollers 212L and 212R. The drive swivel mechanisms 211L and 211R respectively include registration drive motors M1L and M1R, each serving as a second motor. Further, the drive swivel mechanisms 211L and 211R respectively include steering motors M2L and M2R, each serving as a third motor, motor gears 213L and 213R, drive input gears 214L and 214R, and steering shafts 215L and 215R.

Rotation shafts of the registration drive motors M1L and M1R are respectively drivingly connected to the registration drive rollers 212L and 212R. That is, the registration drive rollers 212L and 212R are independently rotatably driven at variable rotational speeds by rotations of the registration drive motors M1L and M1R, respectively.

The steering shafts 215L and 215R respectively rotatably support frames 216L and 216R (refer to FIG. 3) respectively supporting the registration drive rollers 212L and 212R and the registration drive motors M1L and M1R. That is, the registration drive rollers 212L and 212R, and also the registration drive motors M1L and M1R are respectively rotatably supported around the steering shafts 215L and 215R, whose axial directions intersect with (are perpendicular to) both the sheet conveyance direction V and a sheet width direction W perpendicular to the sheet conveyance direction V, as a center.

On the other hand, the steering motors M2L and M2R are respectively arranged along axial directions that are parallel to the axial directions of the steering shafts 215L and 215R, and the motor gears 213L and 213R are respectively secured to rotation shafts of the steering motors M2L and M2R. The drive input gears 214L and 214R respectively secured to the steering shafts 215L and 215R are respectively engaged with the motor gears 213L and 213R. Thereby, by controlling rotations of the steering motors M2L and M2R, it becomes possible to swivel (turn) the registration drive rollers 212L and 212R and the registration drive motors M1L and M1R around the steering shafts 215L and 215R as a center.

In other words, the registration drive rollers 212L and 212R are respectively rotatably driven by the registration drive motors M1L and M1R, and are respectively swiveled to a direction inclined with respect to the sheet conveyance direction V by the steering motors M2L and M2R. Thereby, each of the registration roller pairs 240L and 240R can independently change a conveyance speed, and can independently change the sheet conveyance direction.

To be noted, home position sensors SN3L and SN3R are respectively arranged in areas adjacent to the registration drive rollers 212L and 212R. Home positions of the registration drive rollers 212L and 212R are respectively detected by these home position sensors SN3L and SN3R. The home positions of the registration drive rollers 212L and 212R are, in other words, positions at which the registration roller pairs 240L and 240R face straight (without any inclination) in the sheet conveyance direction V. That is, the detection of the home position sensors SN3L and SN3R enables the registration roller pairs 240L and 240R to return to the positions at which the registration roller pairs 240L and 240R are aligned with respect to the sheet conveyance direction V without any inclination.

### Configuration for Detecting Skew of Sheet

In areas adjacent to nips of the registration roller pairs 240L and 240R, leading edge registration sensors SN2L and SN3R constituted by, for example, optical sensors are each arranged at the same positions along the sheet conveyance direction V (that is, aligned in the sheet width direction W). A controller 10 (refer to FIG. 1), serving as a control unit, calculates a skew amount of the sheet S based on a timing difference when the leading edge registration sensors SN2L and SN2R each detect a leading edge of the sheet S, and a conveyance speed at which the sheet S is conveyed. To be noted, while, in the present embodiment, the skew amount of the sheet S is detected by the plurality of leading edge sensors SN2L and SN2R, it is not limited to this, and it is acceptable to use other methods such as a method in which the skew of the sheet S is detected by analyzing the image using such as image sensors which capture the image.

### Configuration for Detecting Position of Sheet in Sheet Width Direction

Image sensors SN1L and SN1R are respectively arranged upstream of the registration roller pair 240L and downstream of the registration roller pair 240R in the sheet conveyance direction V. The image sensors SN1L and SN1R respectively detect positions of a left side edge and a right side edge of the sheet S. These image sensors SN1L and SN1R can use optical sensors, such as a contact image sensor (CIS sensor). Then, the controller 10 calculates a position of the sheet S in the sheet width direction (so-called lateral registration position) based on the edge positions of the left and right edges.

To be noted, while, in the present embodiment, the positions of both the edges of the sheet S in the sheet width direction W are detected by the two image sensors SN1L and SN1R, it is not limited to this, and it is acceptable to detect the positions of both the edges of the sheet S using a single image sensor that is longer in the sheet width direction than a region through which the sheet S passes. Further, by detecting a position of an edge on one side by a single image sensor, it is acceptable to calculate a position of an edge on the other side in the sheet width direction based on a sheet size that has been input into the controller 10 (or a sheet size detected at the other site). Further, by detecting a position of an edge on one side by a single image sensor, it is acceptable to control the displacement of the sheet S in the sheet width direction W (lateral registration) using the position of the edge on the one side as a reference position.

### Operation in Print Module

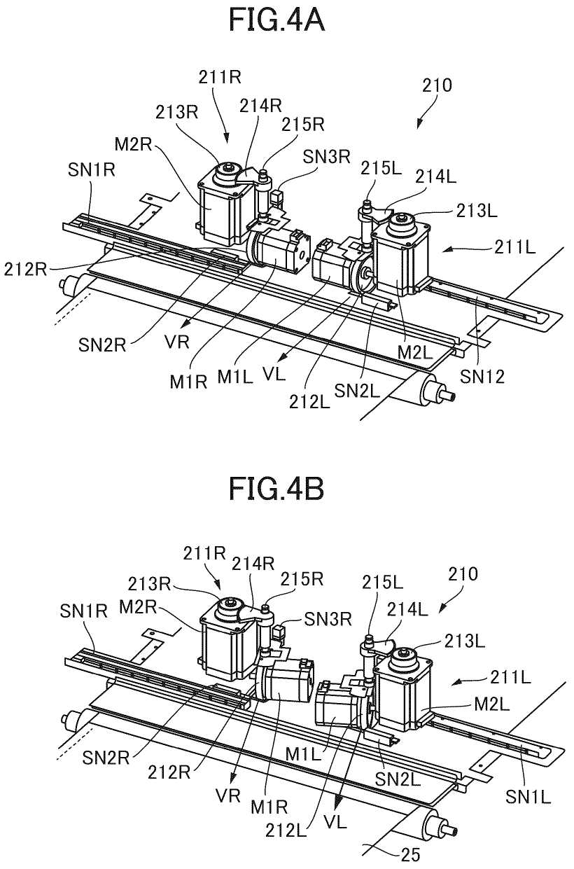

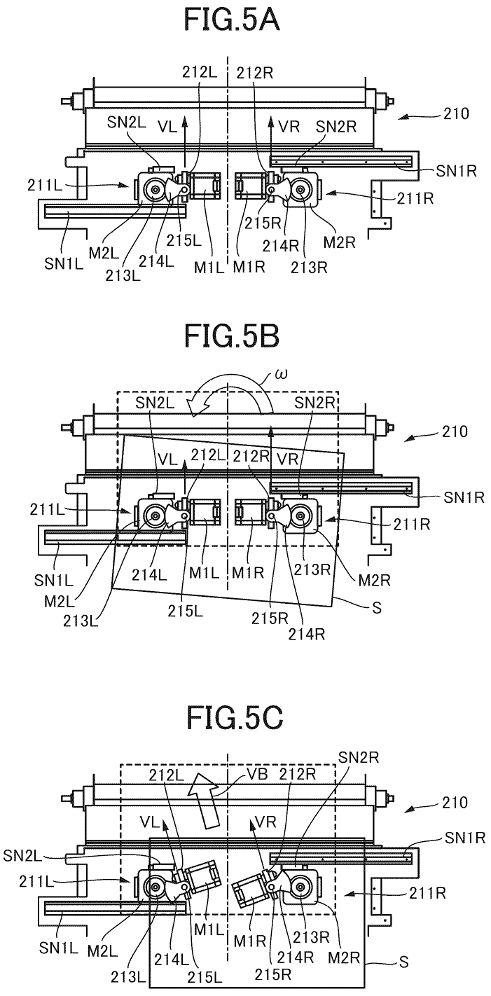

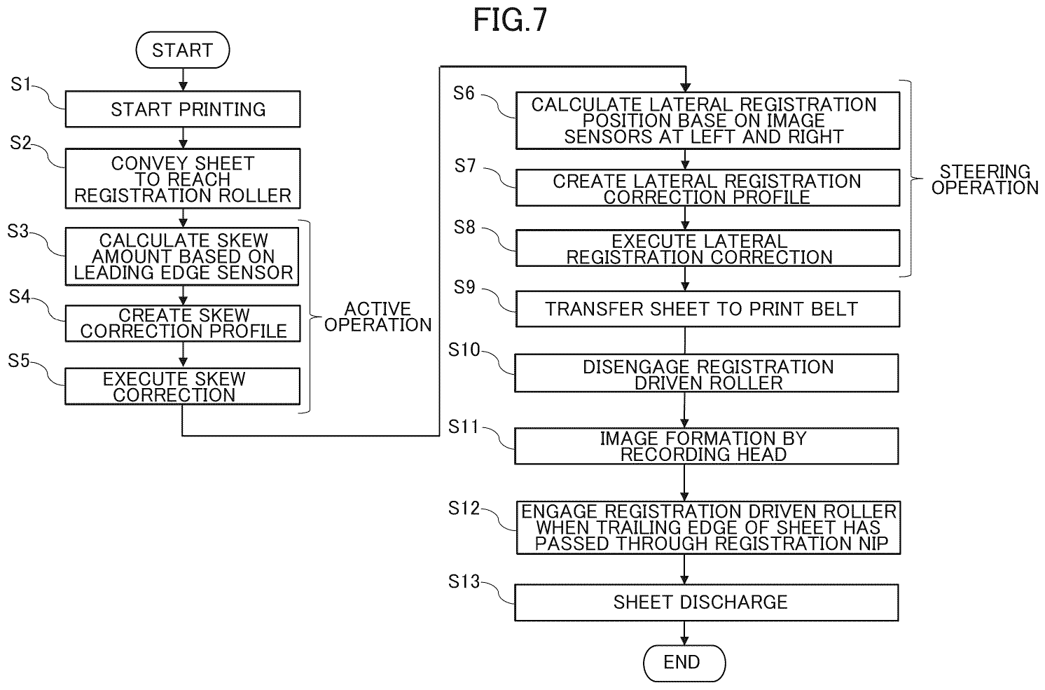

Next, using FIGS. 4A, 4B, 5A, 5B, 5C, and 7, an operation of the print module 200 will be described. FIG. 4A is a perspective view illustrating the registration unit before the registration drive rollers are swiveled. FIG. 4B is a perspective view illustrating the registration unit after the registration drive rollers have been swiveled. FIG. 5A is a top view illustrating the registration unit before the sheet is conveyed. FIG. 5B is a top view illustrating the registration unit that is in a state of performing the skew correction of the sheet. FIG. 5C is a top view illustrating the registration unit that is in a state of performing the lateral registration correction of the sheet. FIG. 7 is a flowchart illustrating the control of the print module of the present embodiment. To be noted, while, in the control of image formation illustrated in FIG. 7, an example of forming the image on one side of the sheet is described, in a case of forming the image on both surfaces of the sheet, this control is repeatedly executed.

In the print module 200, detection results are input to the controller 10 from the image sensors SN1L and SN1R on the left and right, and the leading edge registration sensors SN2L and SN2R on the left and right. Based on these detection results, by controlling the registration drive motors M1L and M1R on the left and right and the steering motors M2L and M2R on the left and right, the controller 10 performs the skew correction and the lateral registration correction while conveying the sheet. To be noted, the term “skew correction” here refers to the correction of inclination with respect to the sheet conveyance direction V, and the term “lateral registration correction” refers to the correction of the displacement from a reference position in the sheet width direction W. However, in the present embodiment, basically, a purpose of the registration unit 210 is to correct the skew of the sheet, and, often, as a result of the correction of the skew, it becomes necessary to adjust the position of the sheet in the sheet width direction W. Therefore, the corrections that include these both corrections are also referred to as the skew correction in a broad sense.

First, the controller 10 starts the control of the image formation illustrated in FIG. 7 at the timing when receiving a print job directly from an operation unit, not shown, or from an external computer connected via a network. The print job which the controller 10 receives includes information specified by a user, such as the number of prints, and the size of the sheet S on which the printing is performed. That is, the controller 10 determines a start of the printing in accordance with the received print job (STEP S1).

Next, the controller 10 selects the size of the sheet S specified by the print job from, for example, any of the storage compartments 110a, 110b, and 110c, and controls the feed module 100 to feed the sheet S. Then, by driving such as driving motors, the controller 10 conveys the sheet S toward the registration unit 210 by the conveyance roller pairs 208 and 209 (refer to FIG. 2), and conveys the sheet S to reach the registration roller pairs 240L and 240R (STEP S2).

Next, the controller 10 calculates and determines the posture of the sheet S (skew amount) based on the detection results input from the leading edge sensors SN2L and SN2R (STEP S3). To be noted, the posture of the sheet S (skew amount) mentioned here refers to an inclination angle with respect to the sheet conveyance direction V, or more precisely, the inclination angle at the leading edge of the sheet S with respect to the sheet width direction W. In particular, as described above, the controller 10 determines the inclination angle of the sheet S based on the timing difference when the two leading edge sensors SN2L and SN2R each detect the leading edge, and the conveyance speed of the sheet S.

Next, based on the inclination angle of the sheet S determined as described above, the controller 10 creates a skew correction profile of the registration roller pairs 240L and 240R for correcting the skew of the sheet S (STEP S4). Then, in accordance with the skew correction profile, the controller 10 performs the skew correction (active operation) (STEP S5).

In particular, when, based on an instruction from the controller 10, the registration drive motors M1L and M1R are driven in accordance with the skew correction profile, rotational speeds of the registration roller pairs 240L and 240R are independently drive controlled. For example, in the state illustrated in FIGS. 4A and 5A, the registration drive motors M1L and M1R are controlled such that the registration roller pairs 240L and 240R respectively attain conveyance speeds VL and VR. Here, as illustrated in FIG. 5B, the inclination angle of the sheet S, which is conveyed in a skewed manner, is detected, and the skew correction profile is created, so that the registration drive motors M1L and M1R are independently drive controlled in accordance with the skew correction profile. Then the conveyance speed VR of the registration roller pair 240R is controlled to become larger than the conveyance speed VL of the registration roller pair 240L. Thereby, the sheet S is swiveled as illustrated by an arrow ω, and the skew of the sheet S is corrected as illustrated by dashed lines in FIG. 5B.

Next, as illustrated in FIG. 7, based on the detection results of the image sensors SN1L and SN1R on the left and right, the controller 10 calculates the lateral registration position (lateral displacement amount) of the sheet S, namely positions of both the edges of the sheet S in the sheet width direction W (STEP S6). In particular, the controller 10 detects the positions of both the edges of the sheet S in the sheet width direction W by detecting the extent to which the sheet S covers the image sensors SN1L and SN1R, and calculates the lateral displacement amount from the positions of both the edges.

Next, based on the calculated lateral registration position of the sheet S, the controller 10 creates a lateral registration correction profile of the registration roller pairs 240L and 240R for correcting the lateral registration (lateral displacement) of the sheet S (STEP S7). Then, in accordance with the lateral registration correction profile, the controller 10 performs the lateral registration correction (steering operation) (STEP S8).

In particular, when, based on the instruction from the controller 10, the steering motors M2L and M2R are driven in accordance with the lateral registration correction profile, rotational angles of the registration roller pairs 240L and 240R are independently drive controlled. For example, in the state illustrated in FIGS. 4A and 5A, by the steering motors M2L and M2R, angles of the registration drive rollers 212L and 212R are controlled to be positioned at positions respectively detected by the home position detection sensors SN3L and SN3R described above. Therefore, the registration roller pairs 240L and 240R are positioned to face straight in the sheet conveyance direction V. Here, as illustrated in FIG. 5C, the lateral registration position of the sheet S, which is conveyed with the lateral displacement, is detected, and the lateral registration correction profile is created, so that the steering motors M2L and M2R are independently drive controlled in accordance with the lateral registration correction profile. Then, each of the registration roller pairs 240L and 240R is swiveled, and the registration roller pairs 240L and 240R are respectively controlled to convey the sheet S at the conveyance speeds VL and VR in a direction in which each of the registration drive rollers 212L and 212R is swiveled. Thereby, the sheet S is conveyed while moving in the sheet width direction W as illustrated by an arrow VB, the lateral registration position of the sheet S is corrected to align with a reference position (position aligned with a conveyance center) as illustrated by dashed lines in FIG. 5C. To be noted, in this lateral registration correction, under normal conditions where the skew correction is not performed, the rotational angles of the registration roller pairs 240L and 240R are controlled to be the same so as to allow the conveyance speeds VL and VR to become the same.

Next, as illustrated in FIG. 7, the controller 10 transfers the sheet S to the print belt 25 (refer to FIG. 2) after the completion of the lateral registration correction (STEP S9). Then, after the transfer of the sheet S to the print belt 25, the controller 10 disengages the registration driven rollers 252L and 252R respectively from the registration drive rollers 212L and 212R by the separate mechanism 270 (STEP S10), described in detail below.

Next, the controller 10 forms the image with respect to the sheet S by the recording unit 230 (STEP S11). Further, when a trailing edge of the sheet S has passed through nips (registration nips) of the registration roller pairs 240L and 240R, the controller 10 respectively brings the registration driven rollers 252L and 252R into contact with the registration drive rollers 212L and 212R by the separate mechanism 270 (STEP S12), described in detail below. Then, the controller 10 discharges the sheet S toward the sheet discharge module 700 (refer to FIG. 1) (STEP S13). Thereby, the controller 10 ends the print job, and completes an image forming operation with respect to a single sheet of the sheet.

To be noted, in a case of duplex printing in which the image formation is performed on both surfaces (front and back surfaces) of the sheet S, after the operation of STEP S13, the controller 10 reverses the sheet S in the reverse module 600, and again conveys the sheet S toward the registration roller pairs 240L and 240R. Then, the controller 10 performs the operations after STEP S2 similarly.

Further, while, in the flowchart illustrated in FIG. 7, the skew correction (active operation) and the lateral registration correction (steering operation) are performed separately, it is acceptable to perform both the corrections simultaneously by combining these skew correction and lateral registration correction.

### Configuration of Registration Driven Roller

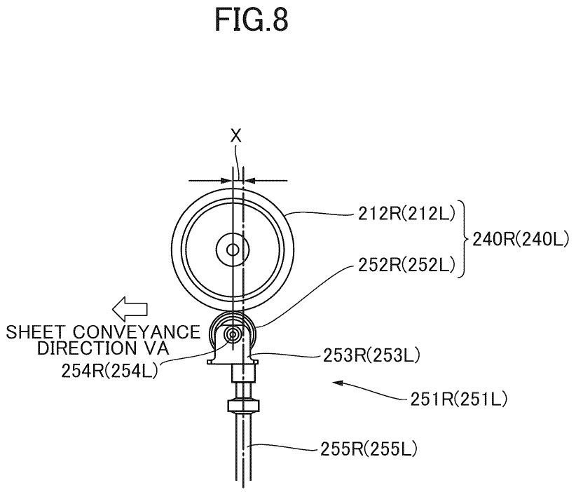

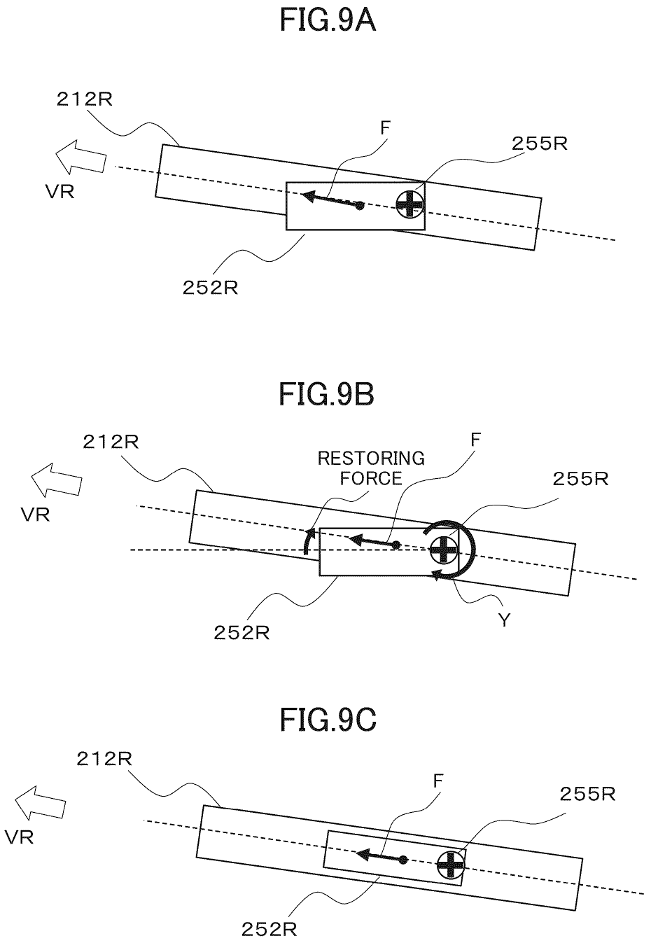

Next, using FIGS. 8, 9A and 9B, configurations of the registration driven rollers 252L and 252R will be described. FIG. 8 is a cross-sectional view illustrating the registration roller pair of the present embodiment. FIG. 9A is a diagram illustrating a state immediately after the registration drive roller has swiveled. FIG. 9B is a diagram illustrating a restoring force generated in the registration driven roller when the registration drive roller has swiveled. FIG. 9C is diagram illustrating a state in which the registration driven roller has swiveled due to the swiveling of the registration drive roller.

As illustrated in FIG. 8, the registration roller pair 240R (240L) includes the registration drive roller 212R (212L) and the registration driven roller 252R (252L). Among those, the registration driven roller 252R (252L) is incorporated in a registration driven roller unit 251R (251L). The registration driven roller unit 251R (251L) is constituted from the registration driven roller 252R (252L) described above, a driven roller rotation shaft 254R (254L), a swivel rotation shaft 255R (255L), serving as a first support shaft (a second support shaft), and a frame 253R (253L). To be noted, since the registration driven roller 252L and the registration driven roller 252R are the same in a configuration, in the following description of the registration driven roller, the registration driven roller 252R will be described, and the description of the registration driven roller 252L will be omitted herein.

In particular, the driven roller rotation shaft 254R is rotatably supported by the frame 253R, and the registration driven roller 252R is fixedly supported by the driven roller rotation shaft 254R. Further, the frame 253R is supported by the swivel rotation shaft 255R in a manner capable of swiveling (rotatably) around the swivel rotation shaft 255R as a center. That is, the registration driven roller 252R can swivel around the swivel rotation shaft 255R as a center. Further, the swivel rotation shaft 255R is arranged with an offset by a distance X with respect to the nip portion of the registration drive and driven rollers 212R and 252R in the sheet conveyance direction. This distance X is referred to as a caster trail.

Next, a swiveling operation of this registration driven roller 252R will be described in detail. When the registration drive roller 212R is operated at a predetermined alignment, the registration driven roller 252R that is urged toward the registration drive roller 212R by a spring 273 of the separate mechanism 270, described in detail below, is rotatably driven by receiving a friction force of the nip portion with the registration drive roller 212R. At this time, as illustrated in FIG. 9A, by the rotation of the registration drive roller 212R, the registration driven roller 252R receives a force in a vector direction illustrated by an arrow F. The swivel rotation shaft 255R of the registration driven roller unit 251R is positioned at the distance X, serving as the caster trail, in the sheet conveyance direction away from the position of the nip portion that receives the force in the vector direction. Therefore, when the registration drive roller 212R starts the steering operation, the force in the direction of the vector (arrow F) acts in a direction illustrated in FIG. 9A, and creates a state in which the force is applied in a direction inclined with respect to an angle of the registration driven roller 252R.

Then, as illustrated in FIG. 9B, in the registration driven roller 252R, a moment indicated by an arrow Y is generated around the swivel rotation shaft 255R, and generates the restoring force that swivels the registration driven roller 252R in a direction aligned with the registration drive roller 212R. Thus, this restoring force brings the registration driven roller 252R back into alignment. The moment indicated by this arrow Y varies depending on the offset between alignments of the registration drive roller 212R and the registration driven roller 252R, and decreases as the offset is lessened. Therefore, when the vector direction aligns with a rotation direction of the registration driven roller 252R, a swivel force becomes zero. With this mechanism, as illustrated in FIG. 9C, the registration driven roller 252R swivels, and is aligned with the registration drive roller 212R in the sheet conveyance direction.

As described above, in the configuration in which the registration drive roller 212R swivels, there is the predetermined distance (caster trail) between the nip portion of the registration driven and drive rollers 252R and 212R, and a center of the swivel rotation shaft 255R in the sheet conveyance direction. Thereby, when the registration drive roller 212R performs the steering operation, it becomes possible for the registration driven roller 252R to follow.

### Detail of Separate Mechanism

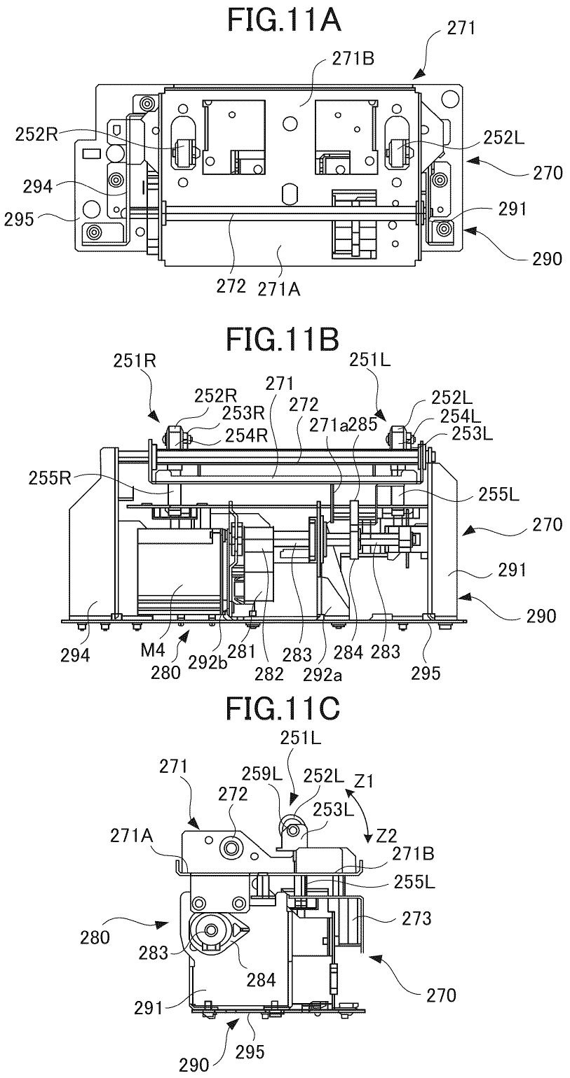

Next, using FIGS. 10, 11A, 11B, and 11C, the separate mechanism 270 capable of moving the registration driven rollers 252L and 252R to contact positions at which the registration driven rollers 252L and 252R respectively come into contact with the registration drive rollers 212L and 212R, and separated positions at which the registration driven rollers 252L and 252R are respectively separated from the registration drive rollers 212L and 212R will be described. FIG. 10 is a perspective view illustrating the separate mechanism of the present embodiment. FIG. 11A is a top view illustrating the separate mechanism of the present embodiment. FIG. 11B is a front view illustrating the separate mechanism of the present embodiment. FIG. 11C is a side view illustrating the separate mechanism of the present embodiment. To be noted, FIGS. 10, 11A, 11B, and 11C are diagrams illustrating only one side of the sheet conveyance path of the sheet S, namely a side on which the registration driven rollers 252L and 252R are present, and, particularly, guide members that form the sheet conveyance path of the sheet S are also omitted.

As illustrated in FIGS. 10, 11A, 11B, and 11C, approximately, the separate mechanism 270 includes a frame portion 290, a swing shaft 272, a swing member 271, serving as an interlocking member, and a drive unit 280. The swing shaft 272 is supported by the frame portion 290, and the swing member 271 is swingably supported by the swing shaft 272. Further, the drive unit 280 drives to swing the swing member 271.

In particular, the frame portion 290 includes a base plate 295 secured to a frame, not shown, located within an interior of a main body of the print module 200. Side plates 291 and 294 disposed upright in a vertical direction are secured to both end portions of the base plate 295 in the sheet width direction W. Further, a support frame body 292 is arranged on the base plate 295 between the side plates 291 and 294 in the sheet width direction W, and side plates 292a and 292b of the support frame body 292 disposed upright in the vertical direction are secured to the base plate 295. Further, the swing shaft 272 described above is secured to and supported by upper end portions of the side plates 291 and 294. Then, the swing member 271 is supported by the swing shaft 272 swingably in directions indicated by arrows Z1 and Z2 around the swing shaft 272 as a center. To be noted, in the swing member 271, one side and the other side opposite to the one side across the swing shaft 272 move in opposite directions in the vertical direction. Hereinafter, the one side and the other side are respectively referred to as a first end portion 271A and a second end portion 271B. That is, the swing member 271 includes the first end portion 271A and the second end portion 271B, and the first end portion 271A is provided at opposite side of the second end portion 271B in a direction intersecting with a center axis of the swing shaft 272.

The second end portion 271B of the swing member 271 comes into contact with the frames 253L and 253R of the registration driven roller units 251L and 251R, described above, from below. Therefore, the swing member 271 synchronizes movements of the registration driven rollers 252L and 252R in the vertical direction, namely with respect to directions moving to the contact positions and the separated positions. Further, the second end portion 271B is urged upward by the spring 273 (refer to FIG. 11C), serving as an urging member, disposed by being compressed between the second end portion 271B and the frame portion 290. Therefore, the registration driven rollers 252L and 252R respectively come into contact with the registration drive rollers 212L and 212R at the contact positions by being respectively urged toward the registration drive rollers 212L and 212R by the spring 273. To be noted, the swivel rotation shafts 255L and 255R of the registration driven roller units 251L and 251R are stretchable, and support the registration drive rollers 212L and 212R movably and are extended in the vertical direction. Further, while the second end portion 271B of the swing member 271 respectively presses the registration driven rollers 252L and 252R via the frames 253L and 253R, the second end portion 271B does not obstruct swivel operations of the registration driven rollers 252L and 252R respectively around the swivel rotation shafts 255L and 255R as centers.

On the other hand, bent portions 271a and 271a are formed to be bent downward in the first end portion 271A of the swing member 271. A supporting shaft 286 is supported by and secured to those bent portions 271a and 271a, and, further, a roller 285 is rotatably supported by the supporting shaft 286. The roller 285 that is supported rotatably with respect to the swing member 271 as described above is pushed by coming into contact with a cam 284, described below, of the drive unit 280.

The drive unit 280 includes a registration disengagement motor M4, serving as a motor, an input gear 282, a rotation shaft 283, and the cam 284. The registration disengagement motor M4 is mounted with respect to the base plate 295 and the support frame body 292, and an output gear 281 is secured to an output shaft of the registration disengagement motor M4. The input gear 282 that is secured to the rotation shaft 283 engages with the output gear 281, and, further, the cam 284 that comes into contact with the roller 285 is secured to the rotation shaft 283. This cam 284 is configured such that a distance from a center of rotation to an outer circumference in this cam varies depending on a rotational direction. To be noted, the rotation shaft 283 is rotatably supported by the side plates 292a and 292b of the support frame body 292.

In a state in which the roller 285 comes into contact with the cam 284 at a position at which the distance from the center of the rotation to the outer circumference in this cam 284 is near the shortest distance, the cam 284 does not push the roller 285 upward. Therefore, the first end portion 271A of the swing member 271 is not pushed upward, and the second end portion 271B is pressed in the arrow Z1 direction by the spring 273 (refer to FIG. 11C). Thereby, the registration driven rollers 252L and 252R are moved so as to be displaced to the contact positions at which the registration driven rollers 252L and 252R respectively come into contact with the registration drive rollers 212L and 212R.

When the controller 10 controls the rotation of the registration disengagement motor M4 to rotate the cam 284 such that the roller 285 is brought into a state in which the roller 285 comes into contact with the cam 284 at a position at which the distance from the center of the rotation to the outer circumference in the cam 284 is near the longest distance, the cam 284 pushes the roller 285 upward. Then, the first end portion 271A of the swing member 271 is pushed upward while resisting the urging force of the spring 273, and the second end portion 271B is lowered in the arrow direction Z2 (refer to FIG. 11C). Thereby, the registration driven rollers 252L and 252R are moved to the separated positions respectively separated from the registration drive rollers 212L and 212R.

### Summary of Present Embodiment

As described above, the separate mechanism 270 of the present embodiment includes the swing member 271 that interlocks the registration driven rollers 252L and 252R with respect to the directions moving to the contact positions and the separated positions. Thereby, the single registration disengagement motor M4, serving as a driving source, is enabled to move the plurality of registration driven rollers 252L and 252R to the contact and separated positions. Therefore, in comparison with a case where solenoid is used to move the registration driven rollers 252L and 252R, it is possible to improve the durability of the registration unit 210. Further, a mechanism that converts a rotational motion of a motor into a reciprocating motion for the movements to the contact and separated positions, and a plurality of motors to drive such a mechanism are not necessary. Therefore, it is possible to miniaturize the entire apparatus, and it is possible to ensure a cost reduction.

Further, the separate mechanism 270 includes the cam 284 that is rotated by the registration disengagement motor M4, and the registration driven rollers 252L and 252R are configured to move to the contact and separated positions when the swing member 271 is moved by the cam 284. Thereby, the rotational motion of the registration disengagement motor M4 can be converted into the reciprocating motion of the registration driven rollers 252L and 252R to the contact and separated positions.

Further, the separate mechanism 270 includes the roller 285, which is rotatably supported by the swing member 271 and is pressed by the cam 284. That is, for example, in a case where the swing member 271 is directly pressed by the cam 284, there is a risk of encountering durability issues due to the wear of the cam 284, particularly, in a case of apparatuses, such as commercial printing machines which print a large volume of sheets. However, it is possible to reduce the wear of the cam 284 through the rotation of the roller 285, and it is possible to improve the durability.

Further, the separate mechanism 270 includes the spring 273 that urges the registration driven rollers 252L and 252R toward the contact positions via the swing member 271. Then, when the swing member 271 is displaced by the cam 284 while resisting the urging force of the spring 273, the registration driven rollers 252L and 252R are moved to the separated positions. That is, it is conceivable that, for example, by eliminating the spring 273, the registration driven rollers 252L and 252R are configured to be respectively pressed to the registration drive rollers 212L and 212R by the own weight of the swing member 271. However, there is a risk that a force by which the sheet S is clamped at the nip portions of the registration driven rollers 252L and 252R and the registration drive rollers 212L and 212R may become insufficient. Since. in the present embodiment, the registration driven rollers 252L and 252R are respectively pressed to the registration drive rollers 212L and 212R by the urging force of the spring 273, it is possible to ensure the force by which the sheet S is clamped at the nip portions.

Further, the separate mechanism 270 includes the swing shaft 272 swingably supporting the swing member 271. Further, in the swing member 271, the first end portion 271A with respect to the swing shaft 272 is pressed to the cam 284. Further, the second end potion 271B is urged by the spring 273, and is interlocked with the registration driven rollers 252L and 252R. With this configuration, for example, in comparison with a case where a long arm or a similar component is utilized to interlock the registration driven rollers 252L and 252R, it is possible to miniaturize the separate mechanism 270.

Further, since the registration drive rollers 212L and 212R are configured to rotate and swivel so as to perform the skew correction and the lateral registration correction, it is necessary to support the registration driven rollers 252L and 252R by the swivel rotation shafts 255L and 255R to allow for swiveling. Then, since these swivel rotation shafts 255L and 255R rotatably support the registration driven rollers 252L and 252R with respect to the swing member 271, it is possible to enable the registration driven rollers 252L and 252R to swivel.

According to this disclosure, it is possible to improve the durability of the skew correction unit, and it is possible to miniaturize the apparatus.

### Other Embodiments

To be noted, in the present embodiment described above, the registration unit 210 performs the skew correction at a position upstream of the recording unit 230, serving as the image forming unit, in the sheet conveyance direction. However, it is not limited to this, and, for example, it is acceptable that registration unit 210 performs the skew correction at a position upstream of such as, for example, an image reading unit reading the image of the sheet, a punching unit punching a hole in the sheet, or a folding unit folding the sheet in the sheet conveyance direction. In short, a sheet conveyance apparatus that performs the skew correction can be any type of apparatus or can be incorporated into any type of apparatus.

Further, in the present embodiment, the movements of the registration driven rollers 252L and 252R are interlocked by the swing member 271 that swings around the swing shaft 272 as a center. However, it is not limited to this, and any interlocking member that can synchronize the movements of the registration driven rollers 252L and 252R in the directions to the contact and separated positions is acceptable. For example, a member that interlocks the frames 253L and 253R which respectively support the registration driven rollers 252L and 252R is acceptable. Further, the interlocking member is not limited to a member that swings, and a member that moves in any direction, such as a member that slides vertically, is acceptable.

Further, while, in the present embodiment, the swing member 271, serving as the interlocking member, is displaced by the cam 284, it is not limited to this, and a member that converts the rotation of the registration disengagement motor M4 into the reciprocating motion by, for example, such as a link mechanism is acceptable.

Further, while, in the present embodiment, the cam 284 presses the swing member 271 via the roller 285, it is not limited to this, and it is acceptable that the cam 284 directly presses the swing member 271. In this case, it is conceivable to apply a coating, which reduces a sliding resistance at a position where the cam 284 comes into contact, or to adhere a material with a low sliding resistance.

Further, in the present embodiment, by urging the swing member 271 by the spring 273, the registration driven rollers 252L and 252R are respectively pressed to the registration drive rollers 212L and 212R. However, it is not limited to this, and a configuration without the use of a spring, such as, for example, a configuration in which, by increasing the weight of the first end portion 271A of the swing member 271, the registration driven rollers 252L and 252R are pressed with the own weight of the swing member 271, is acceptable.

Further, the configuration described in the present embodiment is an example, and various minor modifications are acceptable regardless of their nature. For example, in a relationship such as involving a roller, a rotation shaft supporting the roller, and a supporting member supporting the rotation shaft, any part may be configured to rotate freely.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2023-079472, filed May 12, 2023 which is hereby incorporated by reference herein in its entirety.

What is claimed is:

1. A sheet conveyance apparatus comprising:
a conveyance unit configured to convey a sheet; and
a skew correction unit configured to correct skew of the sheet conveyed by the conveyance unit,
wherein the skew correction unit includes a first skew correction roller pair, a second skew correction roller pair, a first motor, and a separate mechanism,
wherein the first skew correction roller pair includes a first drive roller and a first driven roller arranged to face the first drive roller and configured to be rotatably driven by the first drive roller,
wherein the second skew correction roller pair includes a second drive roller and a second driven roller arranged to face the second drive roller and configured to be rotatably driven by the second drive roller, the second skew correction roller pair being provided in alignment with the first skew correction roller pair in a width direction perpendicular to a sheet conveyance direction,
wherein the separate mechanism includes an interlocking member configured to interlock the first driven roller and the second driven roller, and
wherein the separate mechanism is configured to move the first driven roller and the second driven roller to contact positions and separated positions by driving the first motor to move the interlocking member, the contact positions being positions where the first driven roller and the second driven roller respectively come into contact with the first drive roller and the second drive roller, the separated positions being positions where the first driven roller and the second driven roller are respectively separated from the first drive roller and the second drive roller.

2. The sheet conveyance apparatus according to claim 1,
wherein the separate mechanism includes a cam configured to be rotated by the first motor, and
wherein the separate mechanism is configured to move the first driven roller and the second driven roller to the contact positions and the separated positions in a case where the interlocking member is moved by the cam.

3. The sheet conveyance apparatus according to claim 2, wherein the separate mechanism includes a roller rotatably supported by the interlocking member, the roller being configured to be pushed by the cam.

4. The sheet conveyance apparatus according to claim 2,
wherein the separate mechanism includes an urging member configured to urge the first driven roller and the second driven roller to the contact positions via the interlocking member, and
wherein, in a case where the interlocking member is moved by the cam while resisting an urging force of the urging member, the first driven roller and the second driven roller are configured to be moved to the separated positions.

5. The sheet conveyance apparatus according to claim 4,
wherein the separate mechanism includes a swing shaft configured to swingably support the interlocking member,
wherein the interlocking member includes a first end portion and a second end portion, the first end portion being provided at opposite side of the second end portion in a direction intersecting with a center axis of the swing shaft,
wherein the first end portion is configured to be pushed by the cam, and
wherein the second end portion is configured to be urged by the urging member, the first driven roller and the second driven roller being provided at the second end portion.

6. The sheet conveyance apparatus according to claim 1,
wherein the skew correction unit includes a second motor and a third motor,
wherein the second motor is configured to rotate each of the first drive roller and the second drive roller to convey the sheet in the sheet conveyance direction, and
wherein the third motor is configured to turn each of the first drive roller and the second drive roller around rotation shafts as centers, the rotation shafts being extended in a direction intersecting with the sheet conveyance direction and the width direction.

7. The sheet conveyance apparatus according to claim 6,
wherein the skew correction unit includes
a first support shaft configured to rotatably support the first driven roller with respect to the interlocking member, and
a second support shaft configured to rotatably support the second driven roller with respect to the interlocking member.

8. An image forming apparatus comprising:
the sheet conveyance apparatus according to claim 1; and
an image forming unit configured to form an image on the sheet conveyed by the sheet conveyance apparatus.

9. An image forming system comprising;
the image forming apparatus according to claim 8; and
a processing apparatus configured to perform processing on the sheet on which the image has been formed by the image forming apparatus.
